(19) United States
(12) Patent Application Publication
(10) Pub. No.: US 2016/0381510 A1
(43) Pub. Date: Dec. 29, 2016

(54) METHOD OF LOCATING A MOBILE DEVICE AND A CLOUD COMPUTER SYSTEM EMPLOYING SAME

(71) Applicant: Nearable Technology Corp., Vancouver (CA)

(72) Inventor: Keir REYNOLDS, Vancouver (CA)

(21) Appl. No.: 15/191,235

(22) Filed: Jun. 23, 2016

Related U.S. Application Data
(60) Provisional application No. 62/184,134, filed on Jun. 24, 2015.

(51) Int. Cl. H04W 4/02; H04B 17/318

(52) U.S. Cl. CPC H04W 4/026; H04W 4/02; H04B 17/318

(57) ABSTRACT

A method and system are disclosed for tracking mobile devices. The system comprises a computer cloud having one or more computer servers, and a plurality of mobile devices. Each mobile device broadcasts a Bluetooth Low Energy (BLE) beacon, and also scans BLE beacons broadcast from nearby devices. When one or more mobile devices detect the beacon of another mobile device, they report to the cloud the location ranges of the mobile device that they detected. The cloud then uses the reported location ranges of the mobile device to determine the location of the target mobile device, and reports the determined location to the user of the mobile device.

### CROSS-REFERENCE TO RELATED APPLICATIONS

This application claims the benefit of U.S. Provisional Patent Application Ser. No. 62/184,134, filed Jun. 24, 2015, the content of which is incorporated herein by reference in its entirety.

### FIELD OF THE DISCLOSURE

The present invention relates generally to mobile device location determination, and in particular to a method of positioning a mobile device using wireless signaling and a cloud computer system employing same.

### BACKGROUND

“Smart” mobile devices such as smart phones, tablets, wearable devices and the like have been widely used, and there exists a need for tracking and/or recovering a target mobile device. For example, a problem of mobile devices is that they may sometimes be lost. While most “smart” mobile devices now offer data destruction functions, such as destroying the content stored in the lost mobile device under a remote instruction of the owner of the device, it is still desirable to recover lost mobile devices. Device recovery requires device positioning. However, existing device positioning technologies have their drawbacks. For example, the well-known Global Positioning System (GPS) relies on satellites pre-positioned at known orbital locations, and, as the GPS signal requires line-of-sight communication, GPS cannot be used reliably in in-door environments. Further, different device providers often implement proprietary recovery applications, limiting the scope of recovery opportunities.

It is therefore an object to provide a novel system and method of positioning a mobile device, such as a lost mobile device, and a cloud computer system employing same. Moreover, there is a desire to locate a misplaced target mobile device before it becomes irretrievably lost.

### SUMMARY

According to one aspect of this disclosure, there is disclosed a system for determining the position of at least one target mobile device, each of the at least one target mobile device transmitting a wireless signal. The system comprises: a computer cloud having one or more servers; and one or more orientation mobile devices in communication with the computer cloud; wherein, for each of the at least one target mobile device, the computer cloud performs actions of: receiving a request of a position of said target mobile device; determining a selected group of the one or more orientation mobile devices based on a set of initial information of said target mobile device; instructing the selected group of orientation mobile devices to search for said target mobile device; receiving reference position information from at least one of the selected group of orientation mobile devices; determining the position of said target mobile device based on the received reference position information; and reporting the determined position of said target mobile device; and wherein each of the selected group of orientation mobile devices, upon receiving the instruction of searching the target mobile device, performs actions of: determining the position of said orientation mobile device; detecting the wireless signal transmitted from the target mobile device; identifying an identity of the target mobile device from the detected wireless signal; and reporting detection of the target mobile device, said detection reporting comprising at least the position of said orientation mobile device.

In some embodiments, said detection reporting step further comprises a timestamp indicating the time of detection of the target mobile device.

In some embodiments, each of the selected group of orientation mobile devices, upon receiving the instruction of searching the target mobile device, further performs actions of: measuring the strength of the detected wireless signal; and determining a distance between said orientation mobile device and the target mobile device based on a comparison of the measured signal strength and a predefined reference signal strength.

In some embodiments, the computer cloud further performs actions of: determining a priority weight for each of the at least one target mobile device.

In some embodiments, the wireless signal is a Bluetooth Low Energy (BLE) signal.

In some embodiments, the BLE signal encodes a (UUID, Major ID, Minor ID) triplet for uniquely identifying the target mobile device.

In some embodiments, the BLE signal is structured with a BLE Generic Access Profile (GAP).

In some embodiments, said identifying an identity of the target mobile device from the detected wireless signal comprises: determining a unique fingerprint from the GAP profile; and if said determining a unique fingerprint from the GAP profile fails, establishing a connection with said target mobile device using a BLE Generic Attribute Profile (GATT), for determining a unique fingerprint therefrom.

In some embodiments, said set of initial information comprises an initial location of the target mobile device.

In some embodiments, the initial location of the target mobile device is the last known location of the target mobile device.

According to another aspect of this disclosure, there is disclosed a method for determining the position of at least one target mobile device, said each of the at least one target mobile device transmitting a wireless signal. The method comprises, for each of the at least one target mobile device: receiving a request of a position of said target mobile device; determining a selected group of the one or more orientation mobile devices based on a set of initial information of said target mobile device; detecting, at at least some of the selected group of orientation mobile devices, the wireless signal transmitted from the target mobile device; identifying an identity from the detected wireless signal; determining the positions of the at least some of the selected group of orientation mobile devices; determining the position of said target mobile device using at least the determined positions of the at least some of the selected group of orientation mobile devices; and reporting the determined position of said target mobile device.

In some embodiments, said reporting the determined position of said target mobile device further comprises reporting the determined position of said target mobile device with a timestamp indicating the time of detection of the target mobile device.

In some embodiments, the method further comprises: measuring the strength of the detected wireless signal; and determining a distance between the target mobile device and each of the at least some of the selected group of orientation mobile devices based on a comparison of the measured signal strength and a predefined reference signal strength.

In some embodiments, the method further comprises: determining a priority weight for each of the at least one target mobile device.

In some embodiments, the wireless signal is a Bluetooth Low Energy (BLE) signal structured with a BLE Generic Access Profile (GAP).

In some embodiments, said identifying an identity of the target mobile device from the detected wireless signal comprises: determining a unique fingerprint from the GAP profile; and if said determining a unique fingerprint from the GAP profile fails, establishing a connection with said target mobile device using a BLE Generic Attribute Profile (GATT), for determining a unique fingerprint therefrom.

According to another aspect of this disclosure, there is disclosed an orientation mobile device for determining the position of at least one target mobile device. The orientation mobile device comprises: a processing structure; and a wireless communication component functionally coupled to the processing structure and for receiving a wireless signal; wherein said processing structure executing program-executable code for: receiving a list of identities representing one or more target mobile devices, each identity in the list being associated with a priority weight; selecting at least one identity for searching based on the priority weights of the identities in the list; receiving a wireless signal; determining an ID from the received wireless signal; determining that the ID of the received wireless signal matches at least one of the selected identities; and reporting detection of a target mobile device, said detection reporting comprising at least the position of the orientation mobile device.

In some embodiments, said detection reporting further comprises a timestamp indicating the time of detection of the target mobile device.

In some embodiments, said processing structure further executes program-executable code for: measuring the strength of the received wireless signal; and determining a distance between the target mobile device and the orientation mobile device based on a comparison of the measured signal strength and a predefined reference signal strength.

In some embodiments, the wireless signal is a Bluetooth Low Energy (BLE) signal structured with a BLE Generic Access Profile (GAP), and said determining an ID from the received wireless signal comprises: determining a unique fingerprint as the ID from the GAP profile; and if said determining a unique fingerprint from the GAP profile fails, establishing a connection with said target mobile device using a BLE Generic Attribute Profile (GATT), for determining a unique fingerprint therefrom as the ID.

### BRIEF DESCRIPTION OF THE DRAWINGS

FIG. 1 is a diagram of an example of a cloud computer system, according to an embodiment of the present disclosure;

FIG. 2 shows the hardware structure of a computing device of the cloud computer system of FIG. 1;

FIG. 3 shows a simplified software architecture of a computing device of the cloud computer system of FIG. 1.

FIG. 4A shows a flowchart illustrating the steps of a process for positioning a mobile device performed by the system of FIG. 1;

FIG. 4B is a simplified diagram showing the major data flow during the process of FIG. 4A;

FIG. 5 illustrates the location determination of a target mobile device using an orientation mobile device;

FIG. 6 illustrates the location determination of a target mobile device using three orientation mobile devices;

FIG. 7 illustrates the location determination of a target mobile device using three orientation mobile devices, according to an alternative embodiment;

FIG. 8 is a simplified diagram showing the implementation of the cloud computer system of FIG. 1, according to one embodiment;

FIG. 9A shows an example of implementing the process of FIG. 4 in an Apple® iPhone® device running Apple® iOS® operating system;

FIG. 9B shows an example of implementing the process of FIG. 4 in an Apple® iPhone® device running Apple® iOS® operating system, according to an alternative embodiment;

FIG. 10A shows an example of implementing the process of FIG. 4 in a smartphone running a Google Android™ operating system;

FIG. 10B shows an example of implementing the process of FIG. 4 in a smartphone running a Google Android™ operating system, according to an alternative embodiment;

FIG. 11 is a diagram of an example of a cloud computer system having two subsystems, according to an alternative embodiment;

FIG. 12A shows a flowchart illustrating the steps of a process for positioning a lost mobile device performed by the system of FIG. 11;

FIG. 12B is a simplified diagram showing the major data flow during the process of FIG. 12A; and

FIG. 13 is a flowchart showing the steps of a process executed by an orientation mobile device for obtaining a unique fingerprint or identity representation of a target mobile device using GAP and GATT.

### DETAILED DESCRIPTION

Below, aspects of the system are described. Hereinafter, a mobile device to be or being searched, e.g., a lost mobile device, is denoted as a target mobile device, and is referred using reference numeral 108A. A mobile device that searches one or more target mobile device 108A is denoted as an orientation mobile device, and is referred using reference numeral 108B. Depending on various factors, e.g., location, device manufacturer limitations and the like, an orientation mobile device may not be able to detect a specific target mobile device. On the other hand, once an orientation mobile device detects a target mobile device, the orientation mobile device may track the target mobile device for updating the position of the target mobile device.

As those skilled in the art appreciate, a mobile device in the system disclosed herein may be an orientation mobile device 108B when it is searching for a target mobile device 108A, and may become a target mobile device 108A when it is being searched for, e.g., when it is lost. In some embodiments, a mobile device may be an orientation mobile device 108B and a target mobile device 108A at the same time.

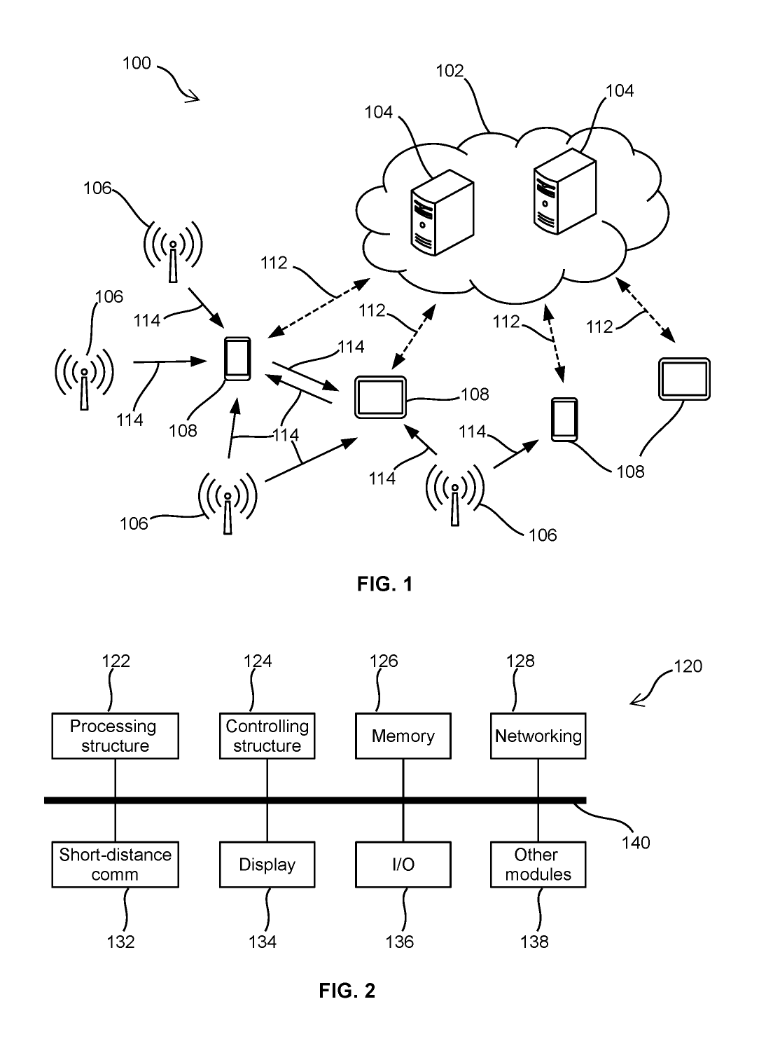

Turning now the FIG. 1, a cloud computer system is shown and is generally identified by reference numeral 100. In this embodiment, the cloud computer system 100 comprises a computer network 102, or a so-called computer cloud, having one or more computing devices 104, usually server computers, interconnected via suitable networking means, such as Internet, a local area network (LAN), a wide area network (WAN) or the like, and via suitable wired and wireless networking connections.

The system 100 also comprises one or more short-distance wireless communication stations 106 deployed in one or more sites, e.g., one or more buildings. Each short-distance wireless communication station 106 communicates with nearby computing devices using a suitable short-distance wireless communication technology (described later) to assist these computing devices to determine their locations and perform other functions.

The system 100 further comprises a plurality of mobile computing devices 108, e.g., smartphones, tablets, Personal Digital Assistants (PDAs), laptops, wearable devices such as “smart” watches, and the like. In some embodiments, the mobile computing devices 108 may be specially-designed, mobile devices that may be attached to an object such as luggage for determining the location thereof. The mobile computing devices 108 are connected to the cloud 102 via suitable wireless networking means 112, such as Wi-Fi®, or 3G or 4G mobile telecommunication. The mobile computing devices 108 also communicate with one or more nearby short-distance wireless communication stations 106 and/or nearby mobile computing devices 108, using suitable short-distance wireless communication technologies such as Bluetooth®, Wi-Fi®, or 3G or 4G mobile telecommunication.

In this embodiment, the short-distance wireless communication technology is a Bluetooth® Low Energy (BLE) technology, such as the iBeacon™ technology specified by Apple Inc. of Cupertino, Calif., U.S.A. or Samsung's Proximity™. Herein, we collectively denote the devices using the BLE technology as BLE devices, including the short-distance wireless communication stations 106 and the mobile computing devices 108. Each BLE device broadcasts a BLE beacon, which in this embodiment includes a triplet of identifiers including a universally unique identifier (UUID), a Major ID and a Minor ID. The UUID generally represents a group, e.g., an organization, a firm, a company or the like, and is the same for all BLE devices in a same group. The Major ID represents a subgroup, e.g., a store or a department of a company, and is the same for all BLE devices in a same subgroup. The Minor ID represents the unique identifier for each BLE device in a subgroup. The combination of the UUID, Major ID and Minor ID, i.e., the triplet (UUID, Major ID, Minor ID), then uniquely determines the identity of the BLE device.

A BLE device, on the other hand, may scan and receive one or more BLE beacons transmitted from other BLE devices. As the BLE beacon transmitted from a BLE device is limited in power, a BLE device, e.g., a mobile computing device 108, can only receive BLE beacons transmitted from devices within a certain range thereof. Moreover, those skilled in the art appreciate that, in various embodiments, a BLE device may only broadcast a BLE beacon (and thus may not have the capability of receiving BLE beacons nor the necessary hardware/software component for BLE beacon receiving), only receive BLE beacons (and thus may not have the capability of broadcasting a BLE beacon nor the necessary hardware/software component for BLE beacon broadcasting), or can broadcast and receive BLE beacons (and thus has the hardware/software components for both broadcasting and receiving BLE beacons), depending on the role thereof in the system. For example, as will be described below, the short-distance wireless communication stations 106 are illustrated in an embodiment in which they may only broadcast BLE beacons.

A BLE device, scanning BLE beacons, may work in a region-monitoring mode or a ranging mode. In the ranging mode, a beacon scanning application program is running in the foreground of the BLE device, and may receive a large number or unlimited number of BLE beacons. In the region monitoring, the beacon scanning application program is running in the background of the BLE device, and is designed to only monitor a limited number of BLE beacons, e.g., up to a maximum of 20 BLE beacons.

In this embodiment, the short-distance wireless communication stations 106 simply broadcast BLE beacons. The mobile computing devices 108, on the other hand, both broadcast BLE beacons and also scan and receive BLE beacons transmitted from nearby devices 106 and 108. After receiving a BLE beacon, a mobile computing device 108 decodes the received BLE beacon to obtain the identity of the device that sends the BLE beacon (i.e., the sender device identity), such as the triplet (UUID, Major ID, Minor ID) embedded in the received BLE beacon, and sends the decoded sender device identity to the cloud 102 for further processing therein and for receiving feedback therefrom. For example, as the short-distance wireless communication stations 106 are deployed in a site in a known manner, their locations in the site are known. Therefore, a server computer 104 in the cloud 102 may determine the location of a mobile device 108 using the sender device identities received by the mobile device 108, and notify the mobile device regarding its location.

Moreover, the cloud 102 (or the server computers 104 therein) may further use the received UUIDs and Major IDs to identify information relevant to the particular subgroup/group, e.g., a targeted promotion of a particular store of a retail company represented by the Major ID and the UUID, and send the identified information to the mobile device 108.

FIG. 2 shows the hardware structure 120 of a computing device 108. The computing device 108 comprises a processing structure 122, a controlling structure 124, memory or storage 126, a networking module 128, a short-distance communication module 132, a display 134, input and output modules 136, and other, optional modules 138, all functionally interconnected by a system bus 140.

The processing structure 122 may be one or more single-core or multiple-core computing processors such as Intel® microprocessors offered by Intel Corporation of Santa Clara, Calif., USA, AMD® microprocessors offered by Advanced Micro Devices of Sunnyvale, Calif., USA, ARM® microprocessors manufactured by a variety of manufactures under the ARM® architecture developed by ARM Ltd. of Cambridge, UK, or the like.

The controlling structure 124 comprises a plurality of controllers, such as graphic controllers, input/output chipsets and the like, for coordinating operations of various hardware components and modules of the computing device 108.

The memory 126 comprises a plurality of memory units accessible by the processing structure 122 and the controlling structure 124 for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, solid-state memory, flash memory, or the like.

The networking structure 128 comprises one or more networking modules for connecting to other computing devices or networks via wired or wireless connections such as Ethernet, WiFi®, Bluetooth®, 3G or 4G mobile telecommunication, ZigBee®, or the like. In some embodiments, parallel ports, serial ports, USB connections may also be used for connecting other computing devices or networks although they are usually considered as input/output interfaces for connecting input/output devices.

The short-distance communication module 132 is a wireless communication module for communication with nearby devices using a suitable short-distance wireless communication technology. In this embodiment, the short-distance communication module 132 is a BLE module broadcasting a BLE beacon and receiving BLE beacons transmitted from nearby devices as described above.

The display 134 comprises one or more display modules for displaying images. In this embodiment, the display 134 is a touch-sensitive LCD or LED display integrated on the mobile device 108. However, those skilled in the art appreciate that, the display 134 may alternatively be other suitable display devices such as cathode ray tube (CRT) monitors, LCD displays, LED displays, projectors, and the like, physically integrated on the mobile device 108 or physically separated therefrom but functionally coupled thereto, depending on the design and implementation.

The input/output (I/O) 136 comprises one or more input components, e.g., a touch-sensitive display, a microphone, an imaging component, a fingerprint scanner, a keyboard, a touch-pad, a computer mouse, or other human interface devices (HID) and the like, for receiving user input, and comprises one or more output components, e.g., speaker(s), vibration components and the like, for outputting information to user. Although the display 134 is listed as a separate module herein, it may also be considered as an output component.

The mobile computing device 108 may also comprise other modules 138 such as a Global Positioning System (GPS) module, an acceleration and motion sensor, e.g., an accelerometer, and the like.

The system bus 140 interconnects various components 122 to 138 enabling them to transmit and receive data and control signals to/from each other.

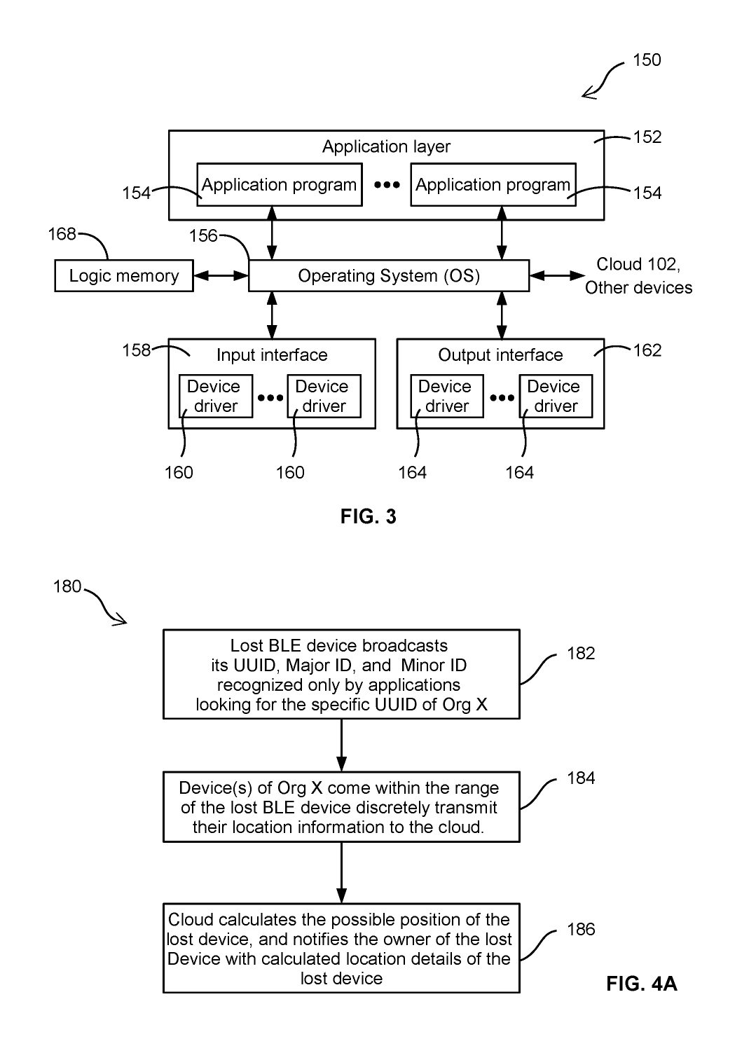

FIG. 3 shows a simplified software architecture 150 of a mobile computing device 108. The software architecture 150 comprises an application layer 152, an operating system 156, an input interface 158, an output interface 162 and logic memory 168.

The application layer 152 comprises one or more application programs 154 executed or run by the processing structure 122 for performing various tasks.

The operating system 156 manages various hardware components of the computing device 108 via the input interface 158 and the output interface 162, manages logic memory 168, and manages and supports the application programs 154. The operating system 156 is also in communication with the cloud 102 and other devices via the networking module 128 and/or the short-distance communication module 132 to assist application programs 154 to communicate with the cloud 102 and other devices as needed. As those skilled in the art appreciate, the operating system 156 may be any suitable operating system such as Apple® iOS®, Android™, Microsoft® Windows™, Apple® OS X®, Linux®, or the like. The computing devices 108 may all have the same operating system, or may have different operating systems.

The input interface 158 comprises one or more input device drivers 160 for communicating with respective input devices, and the output interface 162 comprises one or more output device drivers 164 managed by the operating system 156 for communicating with respective output devices including the display 134. Input data received from the input devices via the input interface 158 is sent to the application layer 152, and is processed by one or more application programs 154. The output generated by the application programs 154 is sent to respective output devices via the output interface 162.

The logical memory 168 is a logical mapping of the physical memory 126 for facilitating access by the application programs 154. In this embodiment, the logical memory 168 comprises a storage memory area (not shown) that is usually mapped to non-volatile physical memory, such as hard disks, solid state disks, flash drives and the like, for generally long-term storing data therein. The logical memory 168 also comprises a working memory area (not shown) that is generally mapped to high-speed, and in some implementations volatile, physical memory, such as RAM, for application programs 154 to generally temporarily store data during program execution. For example, an application program 154 may load data from the storage memory area into the working memory area, and may store data generated during its execution into the working memory area. The application program 154 may also store some data into the storage memory area as required or in response to a user's command.

While a mobile computing device 108 may execute a variety of application programs 154, hereinafter, a device-locating application program 154 offered by the Applicant, Nearable Technology Corp. of Vancouver, BC, Canada, is described, which is executed by the processing structure 122, mostly in background, for positioning mobile devices. The detail of other application programs is omitted.

The server computers 104 of the cloud 102 generally have similar hardware and software structures as described above. In this embodiment, at least one server computer 104 comprises a database storing the device identities, i.e., the (UUID, Major ID, Minor ID) triplets, of the short-distance wireless communication stations 106 in the system 100 for determining the locations of mobile devices 108. At least one server computer 104 also comprises another database storing a lost list comprising the device identities of lost mobile devices for assisting the system to locate lost mobile devices.

As those skilled in the art appreciate, when a mobile device 108 is lost, the user thereof may report to the cloud 102 and mark the lost mobile device as “lost”. While the lost device is still maintaining its short-distance communication with nearby BLE devices, it may not be able to self-report its location to the cloud 102, or the reported location from the lost BLE device is inaccurate. Even if the lost device may successfully report its location, the location reported therefrom may only be available to a particular group of mobile devices, such as only the mobile devices using the same service provider or running the same application program as the lost device. Therefore, in the prior art, locating of a lost device is unreliable, difficult or even impossible. However, in embodiments herein, a lost mobile device may be reliably located with assistance of the cloud 102 and other mobile devices 108 of different manufacturers and/or of different service providers.

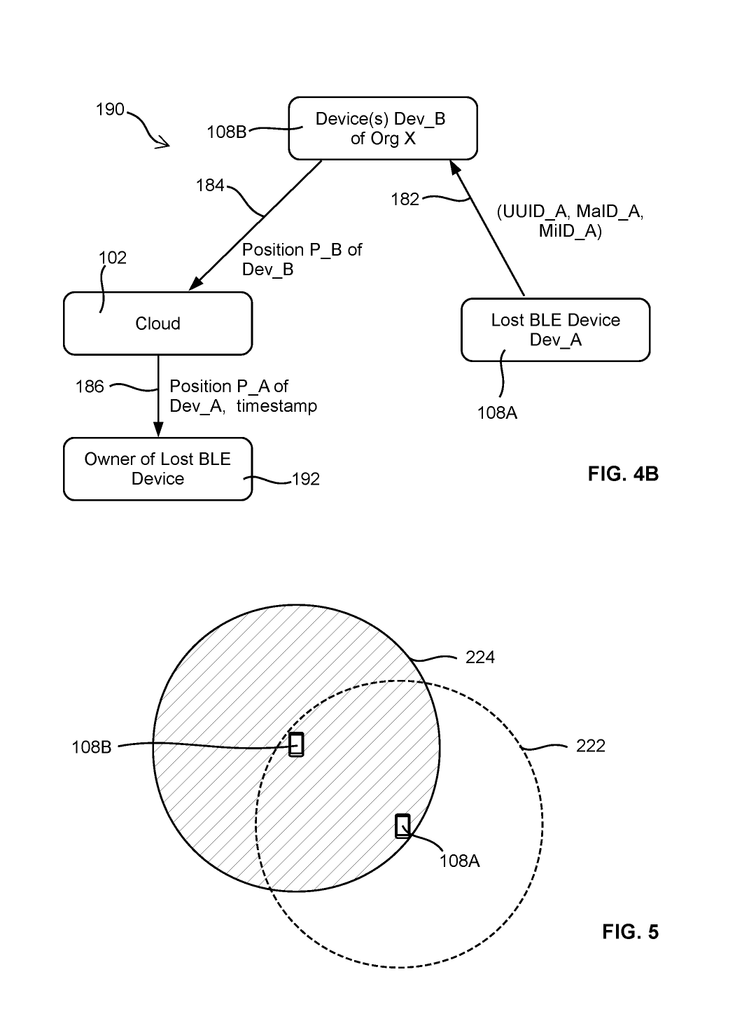

FIG. 4A is a flowchart showing the steps of a process 180 for locating a target mobile device or BLE device 108A such as a lost mobile device, and FIG. 4B shows the major data flow 190 during the process 180 of FIG. 4A. For simplicity and ease of illustration, not all data flow of the system 100 during the process 180 are shown in FIG. 4B.

In this embodiment, all relevant mobile devices are associated with a same organization Org X, e.g., a same mobile telecommunication provider, and have a same UUID, e.g., UUID_A. The target mobile device Dev_A (108A) broadcasts a beacon encoding its (UUID, Major ID, Minor ID) triplet, e.g., (UUID_A, MaID_A, MiID_A) (step 182), which are recognized by the device-locating application programs 154 looking for the specific UUID_A, i.e., the devices associated with Org X. If one or more other mobile devices Dev_B (denoted hereinafter as orientation mobile devices and referenced in FIG. 4B using numeral 108B) come within a predefined range of the target mobile device 108A, the one or more orientation mobile devices 108B detect the beacon of the target mobile device 108A and discover the target mobile device 108A.

As described above, each of the one or more orientation mobile devices 108B obtains its position by scanning the beacons of nearby short-distance wireless communication stations 106, and by using their position information embedded therein. After discovering the target mobile device 108A, each of the one or more orientation mobile devices 108B transmits its own location information P_B, such as its latitude and longitude, to the cloud 102 (step 184). The cloud 102 calculates the possible position P_A of the target mobile device 108A by using the location information P_B of each orientation mobile device 108B, and then notifies the owner of the target mobile device 108A, directly or indirectly, and via suitable means such as an email to a pre-registered email address of the owner or a text message to a pre-registered, alternative phone number of the owner, with the calculated location details P_A of the target mobile device 108A and a timestamp indicating the time that the target mobile device 108A was discovered (step 186).

FIG. 5 shows an example of locating a target mobile device 108A broadcasting a BLE beacon. When an orientation mobile device 108B enters the range 222 of the target mobile device 108A, the orientation mobile device 108B receives the beacon transmitted from the target mobile device 108A. The orientation mobile device 108B decodes the received beacon and determines that the decoded (UUID, Major ID, Minor ID) represents a target mobile device 108A. The orientation mobile device 108B then reports to the cloud 102 its own location and the decoded UUID of the target mobile device 108A. As the target mobile device 108A is only detected by one orientation mobile device 108B, the location of the target mobile device 108A cannot be accurately determined. In fact, it can only be determined that the target mobile device 108A is within a predefined range 224 of the orientation mobile device 108B. Therefore, the cloud uses the position of the orientation device 108B and the range 224 thereof as the reference location information of the target mobile device 108A, and communicates the reference location information and a timestamp indicating the time of detecting the target mobile device 108A, to the device manufacturer, wherein the location of the orientation mobile device 108B is determined from nearby short-distance wireless communication stations 106 as described above, and the timestamp indicates the date and time that the target mobile device 108A was detected by the orientation mobile device 108B. Then, the device manufacturer reports to the owner of the target mobile device 108A about the location of the orientation mobile device 108B, its range 224 and the timestamp. The owner of the target mobile device 108A may then go to the reported location or otherwise arrange for retrieval, and find the target mobile device 108A within the range 224.

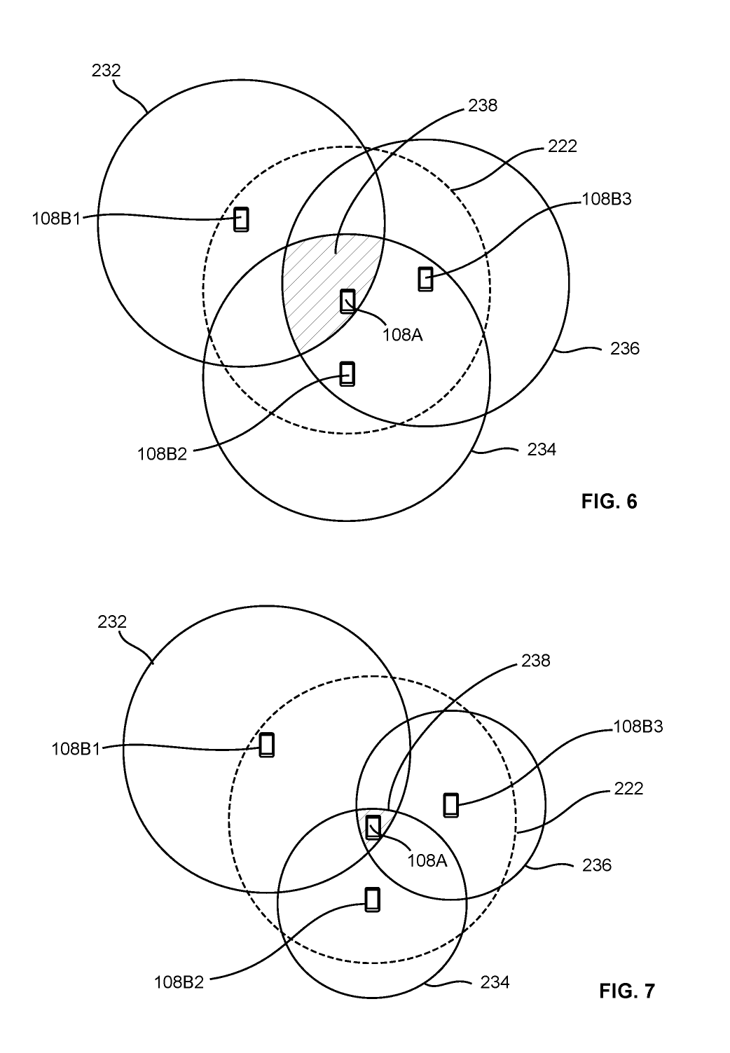

FIG. 6 shows another example of locating a target mobile device 108A. In this example, three orientation mobile devices 108B1 to 108B3 enter the range 222 of the target mobile device 108A and detect the beacon transmitted from the target mobile device 108A, becoming three orientation mobile devices. Following above procedure, the cloud 102 uses the locations of the orientation mobile devices 108B1 to 108B3, and their corresponding ranges 232 to 236 to determine a possible location/range 238 of the target mobile device 108A, and reports the location/range 238 to the owner of the target mobile device 108A.

In above embodiment, the range of an orientation mobile device 108B is predefined. With reference to FIG. 7, in an alternative embodiment, the range of an orientation mobile device 108B may be dynamically determined. In this embodiment, a transmitting BLE device also broadcasts, in its BLE beacon, a reference transmit power. A receiving BLE device may compare the power of the received BLE beacon with the reference transmit power to determine the distance or range from the transmitting BLE device, as shown in FIG. 7 by a size of range 232, 234 or 236. With such distance information, the target mobile device 108A may be more accurately located.

Implementation

Various implementations of the system 100 are now described. In these implementations, the cloud 102 sends a list of target mobile device identities to a selected group of orientation mobile devices 108B for searching. The selected group of orientation mobile devices 108B may comprise one, multiple, or all orientation mobile devices 108B in the system, depending on the implementation and/or the search needs. Different target mobile device identity lists may be sent to different groups of orientation mobile devices 108B, and some or all target mobile device identity lists may comprise same target mobile device identity or identities, as needed. In some embodiments, the cloud 102 may first determine a group of orientation mobile devices 108B for each target mobile device 108A based on a set of initial information of the target mobile device 108A, e.g., by using the geo-prioritization described below, and then compile a target mobile device identity list for each orientation mobile device 108B and send the compiled list thereto. As will be described below, the target mobile device identity list may be a prioritized identity list in which each target mobile device identity is associated with a priority weight. A target mobile device identity associated with a higher priority weight may have higher priority and use more resource during search. For example, a target mobile device identity associated with a higher priority weight may be searched before those associated with lower priority weights, and, once being identified, may be tracked more frequently or for longer time than those associated with lower priority weights.

Upon receiving a target mobile device identity list, each orientation mobile device 108B selects one or more target mobile device identities from the list, based on their associated priority weights, and assigns resources, e.g., beacon slots, for search. Once a target mobile device 108A is identified, the orientation mobile device 108B reports position information, e.g., the position of the orientation mobile device 108B and a timestamp indicating the detection time of the target mobile device 108A, to the cloud 102. The cloud 102 collects the position information of each target mobile device 108A from one or more orientation mobile devices 108B and determines the position or location of the target mobile device 108A as described above. The cloud 102 then reports the determined position of the target mobile device 108A and a timestamp, which may be one of the collected timestamps or a timestamp calculated based thereon, to the owner of the target mobile device 108A.

Those skill in the art appreciate that, in some implementations, an orientation mobile device 108B may randomly select one or more target mobile device identities from the received target mobile device identity list for search.

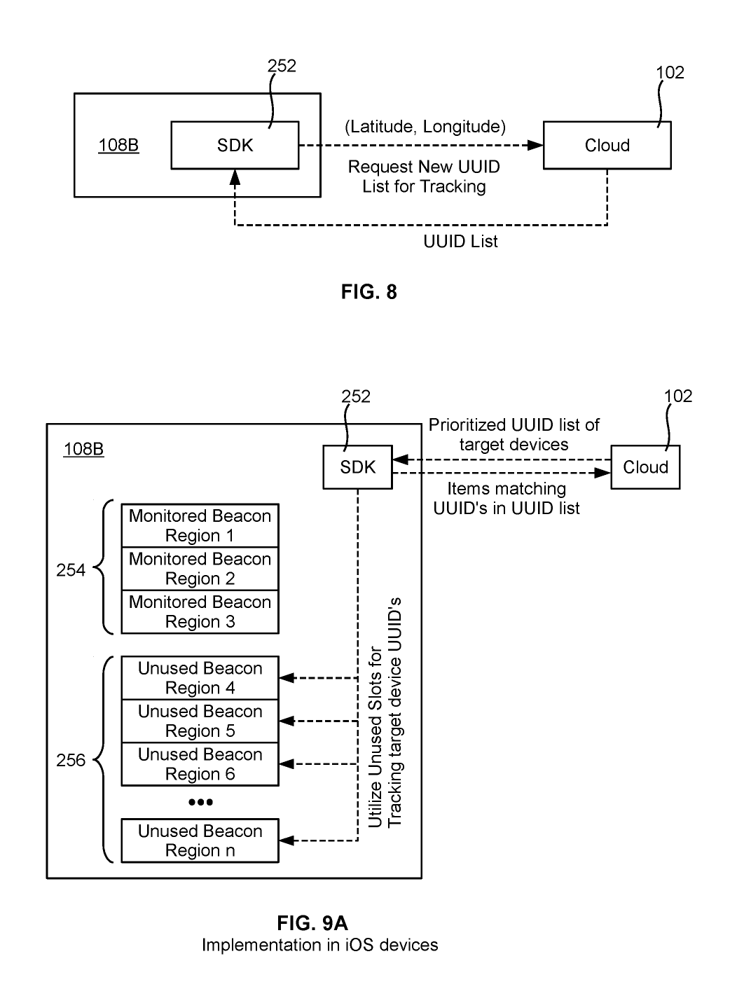

As shown in FIG. 8, a software development kit (SDK) 252, including an application program interface (API), offered by Nearable Technology Corp. of Vancouver, BC, Canada, the Applicant of this disclosure, is provided and installed in each orientation mobile device 108B for implementing the process of FIG. 4A, and for implementing a device-locating application program.

As shown, by using the SDK 252, each orientation mobile computing device 108B in the system 100 periodically communicates, or checks-in, with the cloud 102 (or in particular, the servers 104 of the cloud 102) to report its location, e.g., in the form of a (Latitude, Longitude) pair, and to report the target mobile device(s) 108A it has discovered. During the periodic communication, the servers 104 sends to the orientation mobile device 108B a UUID list of target mobile device(s) 108A, and updates the UUID list with new fingerprint information, e.g., the (UUID, Major ID, Minor ID) triplets, of new target mobile devices 108A. The orientation mobile device 108B then uses the received fingerprint information in subsequent scans to search for target mobile devices 108A. Once a target mobile device 108A is identified, the orientation mobile device 108B sends to the cloud 102 its own location information P_B, such as its own (Latitude, Longitude) pair, for determining the location of the identified target mobile device 108A, and may request for updating the UUID list for target mobile device tracking.

In this embodiment, the UUID list is a prioritized UUID list wherein each UUID in the list is associated with a priority weight. In various embodiments, the priority weight of a UUID may be determined based on various relevant factors. Such factors may be those related to the target mobile device 108A, and/or orientation devices 108B. Examples of such factors for determining the priority weight of a UUID include one or a combination of the time that positioning the UUID was requested (e.g., a UUID of a more recently lost device is assigned a higher priority weight), the distance between the last known position of the target mobile device 108A and the orientation device 108B (e.g., a UUID of a target mobile device 108A closer to the orientation device 108B is assigned a higher priority weight), the ranking of the target mobile device 108A (e.g., a UUID of a target mobile device having a higher ranking is assigned a higher priority weight), and the like. Herein, the last known position of a target mobile device 108A may be the position that the target mobile device 108A most recently reported to the cloud 102 before its communication to the cloud 102 is lost, or may be a position that the owner of the target mobile device 108A reported to the cloud 102. The ranking of a target mobile device 108A may be based on a predefined value of the device (e.g., higher value ranking higher), the service that the user of the target mobile device 108A has subscribed (e.g., a premium service subscription ranking higher), and the like.

For example, in one embodiment, the UUID's in the UUID list are prioritized such that UUID's of the nearby, recently reported lost items have the highest priority weight, followed by UUID's of the nearby, recently discovered lost items, and then UUID's of the mid-range, mid-time lost items. UUID's of other lost items have the lowest priority weight.

The SDK 252 and implementation of the process of FIG. 4A may be dependent on, and adapt to, the types of the mobile devices. For example, the implementation in an Apple® iPhone® device running Apple® iOS® operation system may be different than that in a smartphone running a Google Android™ operating system. Mobile devices 108B leverage specific Bluetooth Low Energy protocols and standards such as iBeacon™, and modifications to the Bluetooth Low Energy advertising packet to broadcast proximity beacons for announcing their presence.

Both iOS® and Android™ have specific and platform-particular limitations toward background scanning of BLE devices, which complicate the task of passively scanning for BLE beacons while other application programs are running on the mobile device.

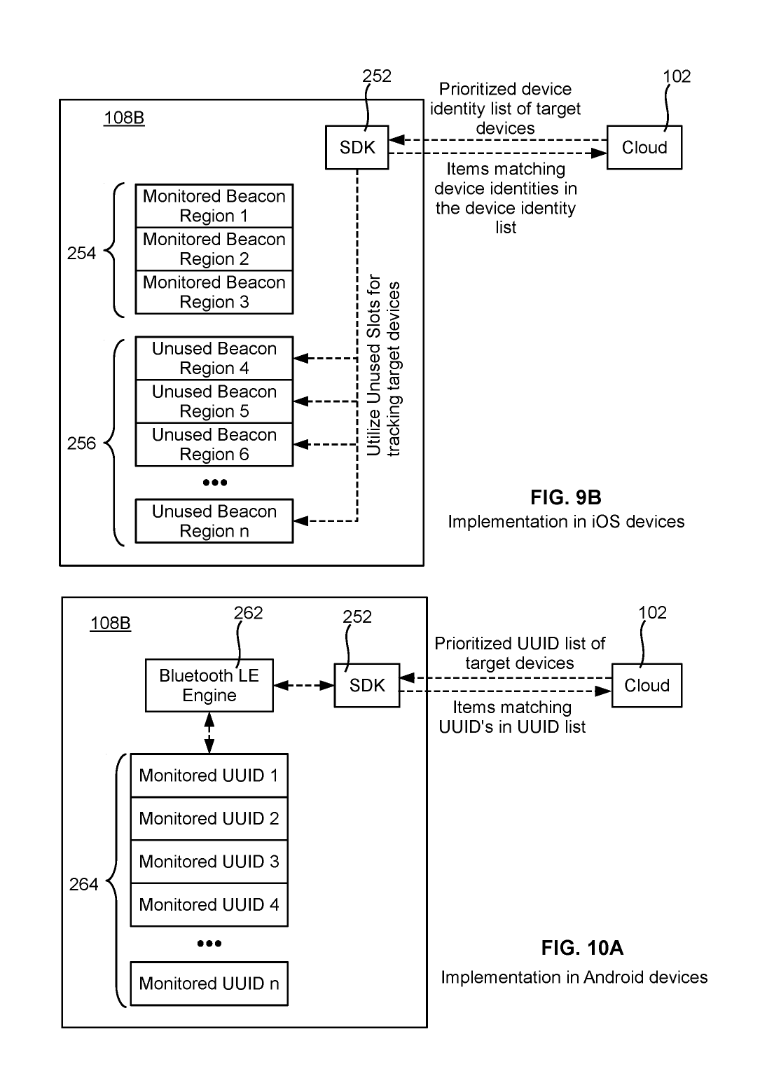

On iOS®, the operating system handles background scanning of BLE beacons on behalf of application programs. Each application program is limited to a finite total number of BLE beacons that can be scanned in the background by the operating system. FIG. 9A shows an example of implementing the process of FIG. 4A in an Apple® iPhone® device running Apple® iOS® operation system. As shown, each iOS® based mobile device 108B executes a device-locating application program/SDK 252. The iOS® operating system allows a maximum of n beacon regions or slots, i.e., allows a maximum of n BLE beacons to be scanned in the background. In the example of FIG. 9A, three beacon regions 254 are currently being used for monitoring some BLE beacons, and the other n−3 beacon regions 256 are unused. The cloud 102 sends a prioritized UUID list of target mobile devices, such as lost mobile devices, to the device-locating application program/SDK 252 of each orientation mobile device 108B.

After receiving the prioritized UUID list of target mobile devices, the device-locating application program 252 utilizes the unused beacon regions or slots 256 for finding and tracking one or more devices having the UUID's in the prioritized UUID list of lost mobile devices. In particular, the device-locating application program 252 utilizes the unused beacon regions or slots 256 for finding the UUID's associated with highest priority weights. If any of these high-priority UUID's are detected, the device-locating application program 252 sends to the cloud 102 the detected device identities, i.e., the (UUID, Major ID, Minor ID) triplets, and tracks them until a stop-tracking notification is received from the cloud 102 or until a predefined time period has expired, depending on the implementation. The cloud 102 further checks the device identities received from the device-locating application program 252, and determines the device identities of target mobile devices.

Once the device-locating application program 252 stops tracking of a detected UUID, the device-locating application program 252 releases the associated beacon region, and uses it to find and track another high-priority UUID in the prioritized UUID list.

FIG. 9B shows an example of implementing the process of FIG. 4A in a device running Apple® iOS® operation system, according to an alternative embodiment. FIG. 9B is similar to FIG. 9A. However, in this embodiment, the cloud 102 sends a prioritized device identity list, e.g., a prioritized list of (UUID, Major ID, Minor ID) triplets, of lost items or mobile devices to the device-locating application program/SDK 252 of each orientation mobile device 108B. The device-locating application program 252 utilizes unused beacon regions or slots 256 for finding and tracking one or more target mobile devices 108A, and sends to the cloud the detected device identities that match the items in the device identity list.

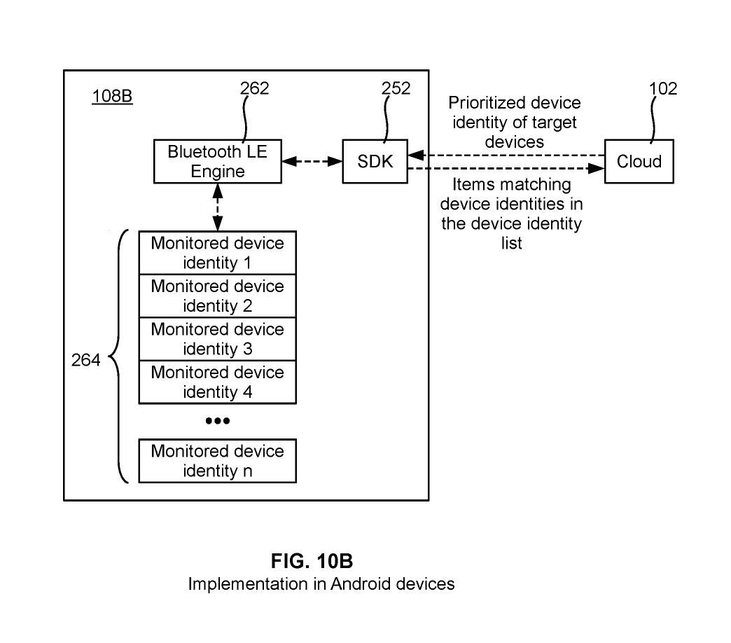

FIG. 10A shows an example of implementing the process of FIG. 4A in a smartphone running a Google Android™ operating system, according to an alternative embodiment. As Android™ does not provide any native support for beacon protocols, accordingly, a BLE beacon engine or subsystem 262 is included in the Android™ based orientation mobile device 108B, for augmenting the Android™ operating system functionality for BLE to create a system capable of scanning BLE Beacon protocols. As shown, the cloud 102 sends a prioritized UUID list of lost mobile devices to the device-locating application program/SDK 252 of each orientation mobile device 108B. The device-locating application program 252 commands the BLE beacon engine 262 to utilize the beacon regions or slots 264 for finding and tracking one or more devices having the UUID's in the prioritized UUID list of lost mobile devices, and sends to the cloud 102 the device identities of detected mobile devices that match the items in the prioritized UUID list of lost mobile devices. The cloud 102 further checks the device identities received from the device-locating application program 252, and determines the device identities of lost mobile devices.

FIG. 10B shows an example of implementing the process of FIG. 4A in a smartphone running a Google Android™ operating system, according to an alternative embodiment. FIG. 10B is similar to FIG. 10A. However, in this embodiment, the cloud 102 sends a prioritized device identity list, i.e., a prioritized list of (UUID, Major ID, Minor ID) triplets, of target mobile devices to the device-locating application program/SDK 252 of each orientation mobile device 108B. The device-locating application program 252 commands the BLE beacon engine 262 to utilize the beacon regions or slots 264 for finding and tracking one or more target mobile devices, and sends to the cloud 102 the detected device identities that match the items in the device identity list.

Battery Management and Preventing Excessive Battery Consumption

The device-locating application program 252 implements a battery management module as needed to minimize the battery power consumption and to prevent the battery from being drained out completely. Optimizations are used to prevent unnecessary battery consumption by the application program and background beacon scanning. In Apple® iOS® platform, the application program and SDK 252 utilize relevant functions provided by the iOS® to manage battery consumption. In Google Android™ platform, an entire beacon scanning stack is provided by in the SDK 252 for minimizing the amount of battery consumed by BLE beacon scanning, including dynamic management of scan frequency based on device state and position, as well as caching and edge detection algorithms which manage how frequently scanned device results are submitted to servers 104 in the cloud 102.

Geo-Prioritization

In some embodiments, the cloud 102 utilizes a geo-aware prioritization queue to rotate the UUID's of target mobile devices through available beacon quota in a seamless manner that does not require additional programming or technical intervention. Prioritizing slots for those devices in a probable geographic area for discovery limits the number of slots needed for target mobile device positioning.

The servers 104 of the cloud 102 run server-side programs for maximizing the probability of finding target mobile devices using heuristics to intelligently prioritize the distribution of the device identities of target mobile devices to mobile devices 108B in the system.

When a mobile device is marked as a target mobile device, e.g., being reported lost, its (UUID, Major ID, Minor ID) triplet is reported to the cloud 102, creating a unique “fingerprint” for the target mobile device. Additionally, an initial location, e.g., the last known (Latitude, Longitude) pair, of the target mobile device is reported to the cloud 102, representing an approximate position to start the search of the device. The initial location of the target mobile device may be reported by the owner of the target mobile device, e.g., via a desktop computer or another mobile device, or may be reported by the target mobile device itself if a location program is still running therein.

After receiving a request of positioning a target mobile device 108A, the cloud 102 uses its initial location, e.g., its last known location, to determine one or more mobile devices 108 likely within a detectable range of the target mobile device 108A, and sends the UUID of the target mobile device 108A to the determined orientation mobile devices 108B for searching. Therefore, other mobile devices 108 out of the detectable range of the target mobile device 108A do not have to search it, saving their beacon slots and energy consumption.

Other Optimizations

Referring again to FIG. 8, those skilled in the art appreciate that other methods for the mobile computing device 108B to periodically communicate with the servers 104 of the cloud 102 are also readily available. For example, Apple® iOS® operating system periodically executes a background update task. In particular, the iOS® operating system usually executes the background update task every several hours, and requires that a background flag to be set for an application program or App to be periodically launched. Such background update task may be used in an alternative embodiment to instruct the operating system to fetch new fingerprint information of target mobile devices 108A from a server 104 periodically.

In another embodiment, every time the device-locating application program is launched, or when a BLE beacon is detected, a background task is executed to fetch the latest list of target mobile devices 108A from a server 104. The disadvantage of this method is that the fetching of the latest list will happen with less predictable frequency.

The cloud 102 dynamically utilizes the locations of the checked-in mobile devices 108B, along with time and statistical distribution to send out fingerprints of target mobile device 108A in an increasing radius over time based on the reported location of the target mobile device 108A. Heuristically, probability of recovery and tracking is increased by distributing high density scan data in the proximity of the target mobile device 108A as soon as possible after the mobile device 108A is reported lost. As time goes on, the search radius is expanded, until it becomes more of a “background” search for given orientation mobile devices 108B.

Likewise, if a target mobile device 108A is located by the cloud 102, it becomes a much higher value target. A proximal set, or a selected group, of orientation mobile devices 108B in the system 100 that were previously located in the area of discovery will receive the fingerprint of the target mobile device 108A, and can passively help to track its movement over time. If the target mobile device 108A is stationary, multiple users will end up marking the location over time. If the target mobile device 108A is moving, a path and pattern for the movement of the target mobile device 108A may be determined by the pattern and frequency in which it is being discovered.

In an alternative embodiment, each mobile device 108 actively reports the detected beacons to the cloud 102. The cloud 102 stores and periodically updates the received beacon information, including the embedded UUID's and their approximate location. Once a mobile device associated with one of these beacons becomes a target mobile device, e.g., being tagged as lost, the cloud 102 searches the stored information and determines the position of the target mobile device.

For example, a user having a mobile device 108B enters a courtyard. The mobile device 108B is running an above-described device-locating application program 252. The mobile device 108B detects five (5) BLE beacons in the courtyard within an about 75 feet range thereof, each detected BLE beacon having a device identity (UUID, Major ID, Minor ID). The mobile device 108B then reports the detected device identities to the cloud with an accompanying geo-location, e.g., Latitude and Longitude coordinates (Latitude, Longitude) of the detecting mobile device 108B, and a timestamp. The cloud 102 stores this data package (UUID, Major ID, Minor ID, Latitude, Longitude, Timestamp) in its database. If one of the five beacons belongs to a target mobile device 108A, the owner of which has requested the cloud 102 to locate it, the cloud 102 then uses the stored data package to determine the location of the target mobile device 108A that is actively being searched for and reports the determined location to the owner of the target mobile device 108A.

In some embodiments, the cloud 102 only sends a subset of the prioritized UUID list to an orientation mobile device 108B to limit the number of slots needed in the orientation mobile device 1086 for target mobile device positioning.

For example, in one embodiment, the cloud 102 checks the UUID of an orientation mobile device 108B, and only requests the orientation mobile device 108B to search for devices having the same UUID. For example, an organization, Org X, may assign only one (1) UUID to all of its mobile devices, while each mobile device has its own, unique Major ID and Minor ID combination. Therefore, when a mobile device of Org X is tagged as lost, the cloud 102 requests other mobile devices of Org X to search for devices having Org X's UUID, ignoring the beacons of other UUIDs (indicating devices of other organizations).

In an alternative embodiment, the system 100 comprises a plurality of subsystems, each having a cloud, a plurality of short-distance wireless communication stations and a plurality of mobile computing devices. Each subsystem is operated by a separate organization and thus has a separate UUID. In this embodiment, if a mobile device of one organization, e.g., Org X, is tagged as lost, the corresponding subsystem may distribute Org X's UUID to mobile devices of some or all other subsystems, so that the mobile devices thereof are utilized to look for and track the beacons with Org X's UUID. The beacons of other UUIDs (indicating devices of other organizations) may be ignored.

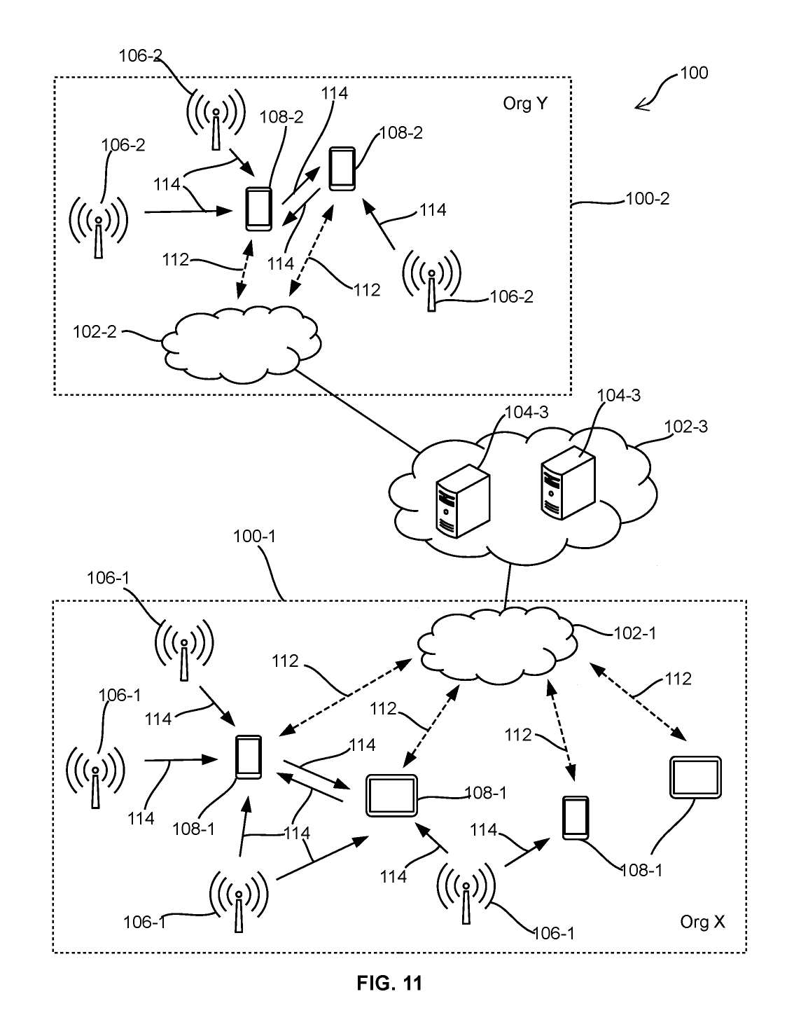

For example, as shown in FIG. 11, the system 100 comprises two subsystems 100-1 and 100-2, each of which comprises a cloud 102-1/102-2, a plurality of short-distance wireless communication stations 106-1/106-2 and a plurality of mobile computing devices 108-1/108-2. In this embodiment, subsystem 100-1 is operated by an operator organization Org X, and subsystem 100-2 is operated by another operator organization Org Y. Mobile devices 108-1 of subsystem 100-1 are only operable in subsystem 100-1, and mobile device 108-2 of subsystem 100-2 are only operable in subsystem 100-2.

Multiple subsystems 100-1 and 100-2 are functionally connected to a central cloud 102-3 having one or more servers 104-3. With the assistance of the central cloud 102-3, the subsystems 100-1 and 100-2 may collaborate with each other to track lost BLE devices.

In this embodiment, each mobile computing device 108-1, 108-2 runs an application program offered by Nearable Technology Corp. of Vancouver, BC, Canada, which is built with an SDK, including an API. The application program and the SDK are built for the operating system running in the mobile computing device 108-1, 108-2. For example, a mobile computing device 108-1, 108-2 with the iOS® operating system runs the SDK for iOS®, and a mobile computing device 108-1, 108-2 with the Android™ operating system runs the SDK for Android™.

The system 100 in this embodiment provides a cloud-based infrastructure to support the ranging and discrete transmission of a lost BLE device's location, regardless whether the lost BLE device is operable in subsystem 100-1 or 100-2.

A BLE device is tied to a specific subsystem or operator organization via its UUID, and is assigned by the specific subsystem a Major and a Minor ID. Many applications (especially those open-sourced on Android) allow ranging of these beacons, however simply discovering the device does not provide details necessary to send location details to the devices owner.

With the integration and use of the Nearable API, SDK for iOS®, and/or SDK for Android™, subsystems 100-1 and 100-2 are able to leverage each other's networks and applications to locate a lost BLE device.

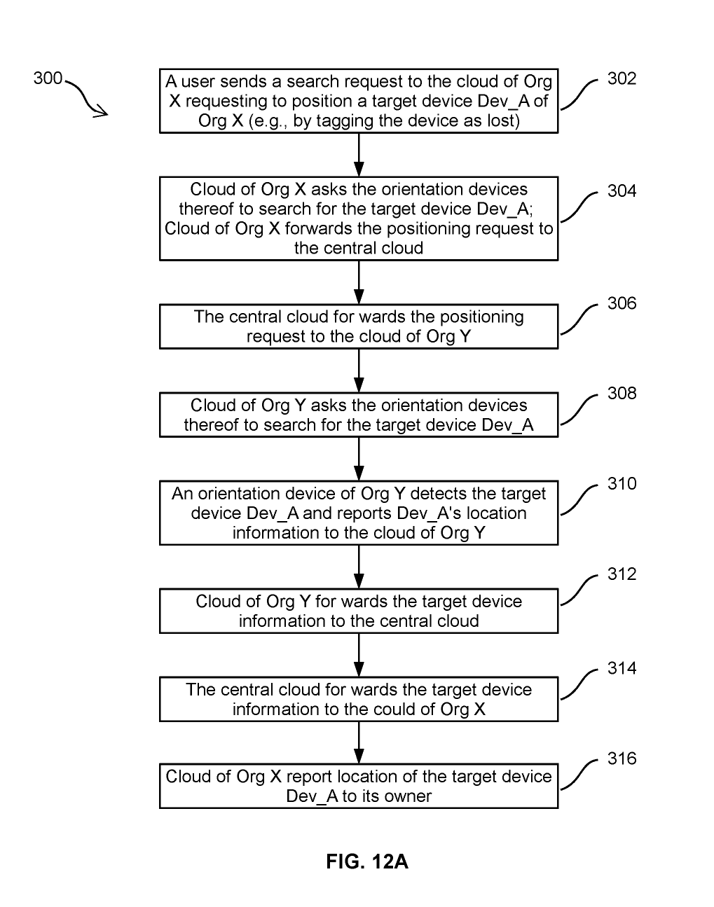

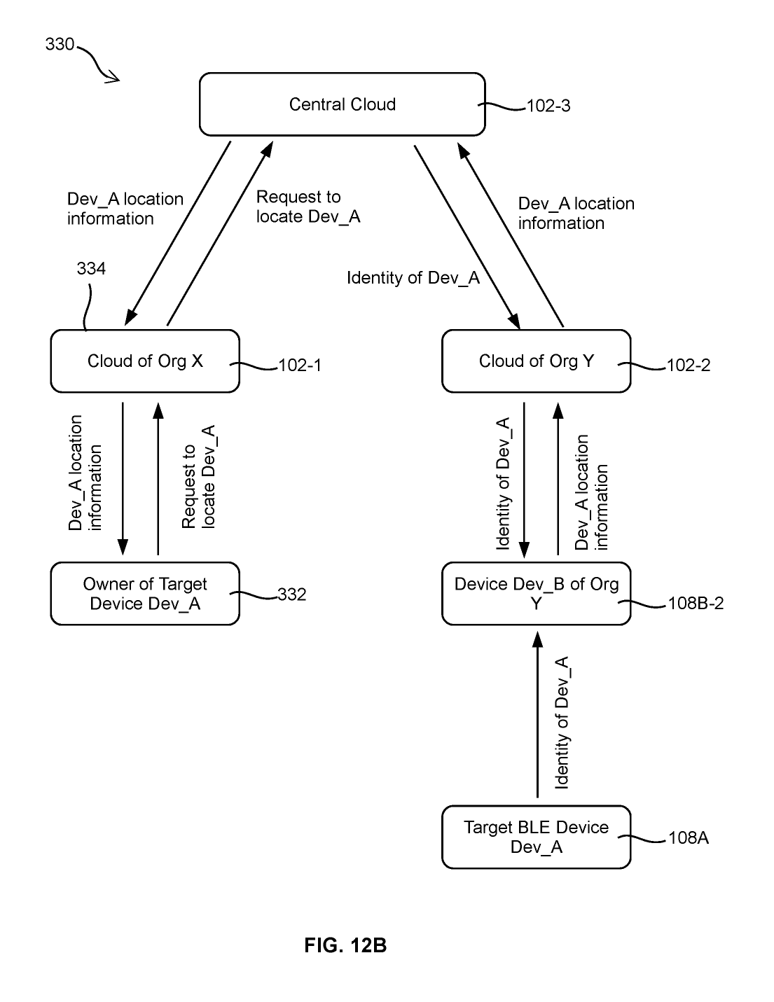

FIG. 12A shows a flowchart illustrating the steps of a process 300 for locating a lost mobile device performed by the system of FIG. 11. FIG. 12B shows the major data flow 330 during the process 300 of FIG. 12A. For simplicity and ease of illustration, not all data flow of the system during the process 300 are shown in FIG. 12B.

As shown, a user 332, who is the owner of a mobile device Dev_A (also referenced using numeral 108A in FIG. 12B) of Org X sends to the cloud 102-1 of Org X a request of a position of the mobile device Dev_A, e.g., by tagging the device Dev_A as lost (step 302). Cloud 102-1 of Org X receives the request, broadcasts the identity of the target mobile device Dev_A, e.g., the (UUID, Major ID, Minor ID) triplet of the target mobile device Dev_A, in an updated UUID list to at least some of orientation mobile devices 108B-1 of Org X, and also forward the position request to the central cloud 102-3 (step 304). At step 306, the central cloud 102-3 forwards the position request to the cloud 102-2 of Org_Y. The cloud 102-2 of Org Y then broadcasts the identity of the target mobile device Dev_A, e.g., the (UUID, Major ID, Minor ID) triplet of the target mobile device Dev_A, in an updated UUID list to at least some of orientation mobile devices 108B-2 of Org Y (step 308). At step 310, an orientation mobile device 108B-2 of Org Y has come within the detectable range of the target mobile device 108A, and identifies the target mobile device 108A. The orientation mobile device 108B-2 then reports the reference location information of Dev_A, e.g., the (Latitude, Longitude) pair of the orientation mobile device 108B-2 and a range between Dev_A and 108B-2, to the cloud 102-2 of Org Y. Cloud 102-2 of Org Y forwards the reference location information of Dev_A to the central cloud 102-3 (step 312), and the central cloud 102-3 forwards the reference location information of Dev_A to the cloud 102-1 of Org X (step 314).

Meanwhile, other orientation mobile devices 108B-1 of Org X and/or other orientation mobile devices 108B-2 of Org Y may also be within a detectable range of the target mobile device Dev_A, and may have identified the target mobile device Dev_A. Cloud 102-1 of Org X collects the reference location information of Dev_A from all orientation mobile devices 108B-1 and 108B-2 of Org X and Org Y, calculates the position of the target mobile device Dev_A, and reports the calculated position information of the target mobile device Dev_A to its owner 332 (step 316).

Similarly, if a mobile device of Org Y becomes a target mobile device, all orientation mobile devices of Org X and Org Y may be utilized to search for the target mobile device of Org Y.

In above embodiment, the cloud 102-1 of Org X collects the reference location information of Dev_A from all orientation mobile devices 108B-1 and 108B-2 of Org X and Org Y, and calculates the position of the target mobile device Dev_A. In an alternative embodiment, the clouds 102-1 of Org X and 102-2 of Org Y both report the reference location information of the target mobile device 108A to the central cloud 102-3

In another embodiment, orientation mobile devices of Org X may be utilized to search target mobile devices of both Org X and Org Y. However, orientation mobile devices of Org Y may only be utilized to search for target mobile devices of Org Y.

In yet another embodiment, prioritization is used such that a target mobile device of Org X having a high priority weight may be searched by orientation devices of both Org X and Org Y. However, a target mobile device of Org X having a low priority weight would only be searched by orientation devices of Org X. In still another embodiment, a priority weight threshold is used for comparing with the priority weight of a target mobile device to determine whether or not other organizations' orientation mobile devices shall be utilized for searching the target mobile device.

In above embodiments, a mobile device 108B receives target mobile device identities or their UUIDs, and only reports to the cloud 102 the identities of the devices it detected whose identities or UUIDs match those received from the cloud. In an alternative embodiment, each mobile device 108B periodically reports its location and the identities of all devices it currently detected to the cloud 102, together with a timestamp. The cloud 102 checks each device identity it receives from each mobile device 108B, and if a device identity matches that of a target mobile device, the cloud determines the location thereof, and reports the determined location to the owner of the target mobile device.

As described above, in some embodiments, the cloud 102 may save a received data package (UUID, Major ID, Minor ID, Latitude, Longitude, Timestamp) in its database. In an alternative embodiment wherein the system comprises a plurality of subsystems as shown in FIG. 11, a cloud of a subsystem, while saving a received data package (UUID, Major ID, Minor ID, Latitude, Longitude, Timestamp) in its database, may also forward the data package to the device manufacturer's cloud or API, e.g., the cloud or API of Org X, and Org X may store the data package in its own database for real-time availability, and/or integrate the data package into their “finding lost device” functionality. Org X may also process the data package for other purposes.

Real-Time Tracking Target Mobile Devices

Although, in above examples, the system 100 is used for finding lost mobile devices, in some other embodiments, the system 100 may be used for tracking the location of one or more target mobile devices therein.

For example, in one embodiment, each orientation mobile device 108B periodically, and normally sufficiently frequently, reports to the cloud 102 its own location and the identities of all devices it currently detected (which may include potential target mobile devices), together with a timestamp. The cloud 102 maintains a database storing the device identity and its location information and updates the database in real-time using the device identity and location information periodically received from the orientation mobile devices 108B. When the cloud 102 receives a request from a user for locating a target mobile device 108A, e.g., luggage having a component emitting a BLE beacon, the cloud 102 searches in the database for the target mobile device 108A. If the target mobile device 108A is found, the cloud determines its location as described above, and reports the determined location to the user.

Once the target mobile device 108A is found, the cloud 102 may also periodically update the determined location of the target mobile device 108A in real-time, and reports the updated location of the target mobile device 108A to the user. Thus, the user can locate and track the target mobile device 108A through the cloud 102 and orientation mobile devices 108B that are unknown to the user but are in proximity with the target mobile device 108A.

In another embodiment, a user may use his/her mobile device to find and track a target mobile device 108A, such as luggage having a component emitting a BLE beacon. The user commands the mobile device to execute an above described application program, and instructs the application program to find the target mobile device 108A. In response to the user's instruction, the application program first searches BLE beacons within a predefined, detectable range, e.g., within 50 feet thereof, and checks if any beacon has the device identity of the target mobile device 108A. If the application program finds such a beacon, the application program reports to the user via a user interface (UI). The application program further tracks the target mobile device 108A in real-time and updates the user regarding the location of the target mobile device 108A.

If, however, the application program does not find the target mobile device 108A, meaning that the target mobile device 108A is not within the detectable range of the user's mobile device, the application program then communicates with the cloud 102, sending thereto a request for searching and tracking the target mobile device 108A, together with the device identity of the target mobile device 108A. The cloud 102 then checks the database for the device identity of the target mobile device 108A. If found, the cloud 102 determines the location of the target mobile device 108A using the beacon information periodically received from orientation mobile devices 108B, which may or may not include the user's mobile device depending on the distance between the target mobile device 108A and the user's mobile device, and reports the determined location to the user. The cloud 102 further updates, and reports to the user, the location of the target mobile device 108A in real time to allow the user to track the target mobile device 108A in real time.

Although in above embodiments, BLE short-distance wireless communication stations 106 are used for mobile devices to determine their locations, in some alternative embodiments, mobile devices may use other technologies to determine their locations. For example, in an embodiment that the mobile devices are located outdoors, the system may not comprise any BLE short-distance wireless communication stations 106, and mobile devices use GPS to determine their locations.

In above embodiments, the identity of a target mobile device 108A identified by an orientation mobile device 108B is sent to the cloud for processing. In some alternative embodiments, the identity of a target mobile device 108A is processed by the orientation mobile device 108B. For example, in one embodiment, some orientation mobile devices 108B may receive reference location information of a target mobile device 108A from the cloud, calculate the location of the target mobile device 108A, and report to the owner of the target mobile device 108A. In another embodiment, all orientation mobile devices 108B can receive reference location information of a target mobile device 108A from other orientation mobile devices 108B, calculate the location of the target mobile device 108A, and report to the owner of the target mobile device 108A. In this embodiment, the orientation mobile devices 108B may form a peer-to-peer network without any server, and thus the system may not comprise a cloud 102.

In above embodiments, a mobile device is identified using its unique (UUID, Major ID, Minor ID) triplet. However, those skilled in the art appreciate that using (UUID, Major ID, Minor ID) triplets is only one way of for identifying mobile devices, and various alternative methods are readily available, depending on the implementation and the wireless communication technologies used.

For example, in one embodiment, manufacturer identifiers may be used for identifying the target mobile devices 108A. In some other embodiments, a “fingerprint” may be derived from the beacon signal of each mobile device for uniquely identifying the mobile device.

For example, in an alternative embodiment, the system 100 uses BLE Generic Access Profile (GAP) and, if needed, Generic Attribute Profile (GATT) for identifying target mobile devices 108A. In comparison with BLE beacons, which are generally one-way signals allowing one-way communication (e.g., broadcasting) only, GAP allows detection of a mobile device, and GATT allow bi-directional Bluetooth connections between mobile devices. GAT and GATT may be exploited for extracting unique fingerprints for mobile devices. Using GAP and GATT also provides enhanced flexibility for using various types of mobile devices in the system 100.

As is known in the art, GAP is used for Bluetooth advertising (i.e., making a BLE device “visible” to other BLE devices) and for establishing connections between BLE devices. A BLE signal structured with GAP comprises an advertising data payload having a plurality of a service UUIDs, and optionally a scan data payload.

GATT determines the detail of data exchange, including profile exchange and user data exchange, via a BLE connection. For example, by using GATT, two BLE devices can agree with data transfer procedures and data formats. A BLE signal with GATT profile comprises a plurality of predefined services, and each service comprises a unique service UUID and one or more characteristics. A list of services and their characteristics may be found in the Bluetooth.org website.

In this embodiment, a mobile device may be identified by extracting unique information stored in one or more properties in GAP, one or more unique values of one or more characteristics, or a combination of both.

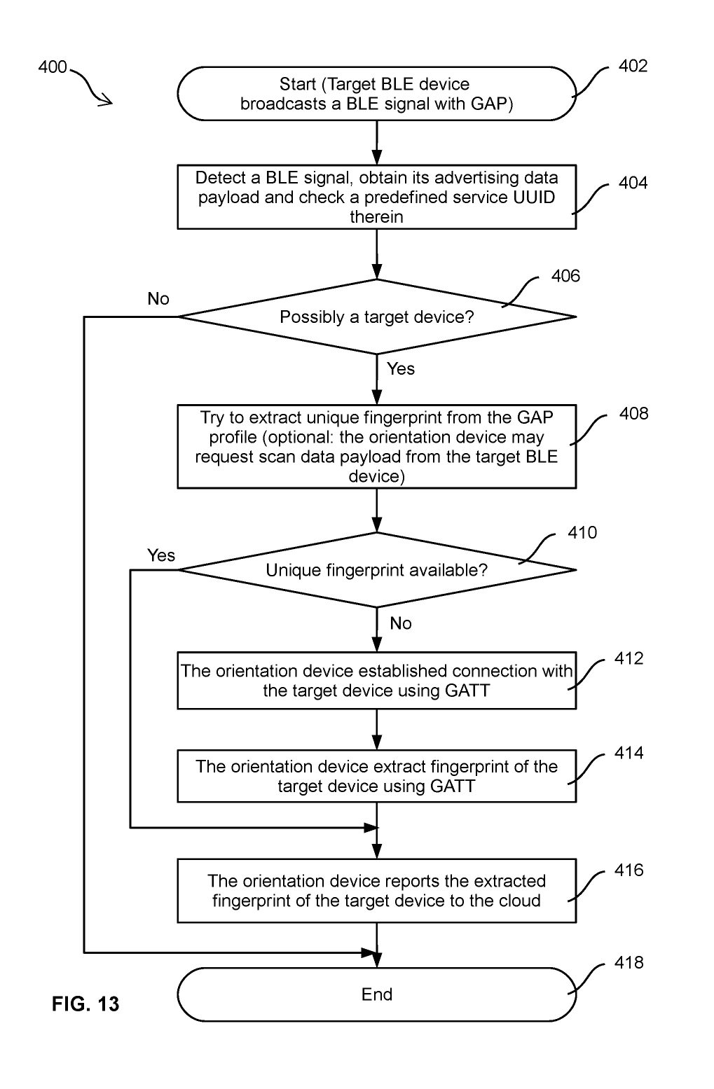

FIG. 13 is a flowchart showing the steps of a process 400 executed by an orientation mobile device 108B for obtaining a unique fingerprint or identity representation of a target mobile device 108A using GAP and GATT. In this embodiment, a target mobile device 108A constantly broadcasts a BLE signal structured with GAP for advertising its existence. The process 400 starts when the orientation mobile device 108B starts to scan GAP-structured BLE signals (step 402).

At step 404, when the orientation device 108B detects a GAP-structured BLE signal, the orientation device 108B obtains the advertising data payload of the BLE signal, and checks a predefined service UUID therein, e.g., the Device Information UUID therein.

If the service UUID is not a UUID of any target mobile device (the “No” branch of step 406), the BLE signal is then ignored and the process is terminated (step 418) so that the orientation mobile device 108B can scan another BLE signal.

If, at step 406, the service UUID is a UUID of a target mobile device (the “Yes” branch of step 406), the device broadcasting the BLE signal is possibly a target mobile device (as multiple mobile devices may have the same service UUID, but may not all be target mobile devices). Then, the orientation mobile device 108B tries to extract a unique fingerprint from the GAP profile of the BLE signal (step 408). At this step, the orientation device 108B may, optionally and/or as needed, request the scan data payload from the target BLE device 108A, and use the advertising data payload and the scan data payload to try to extract a unique fingerprint of the target mobile device 108A. The unique fingerprint may be obtained from manufacturer specific data, or a combination of data of the GAP profile than can uniquely identify the device.

The successfulness of extracting a unique fingerprint of the target mobile device 108A from the GAP profile depends on the manufacturer and/or the service provider of the target mobile device 108A. If the orientation mobile device 108B successfully extracted a unique fingerprint of the target mobile device 108A from the GAP profile (the “Yes” branch of step 410), the process goes to step 416 and the orientation device 108B reports the extracted fingerprint of the target mobile device, as the identity thereof, to the cloud 102 as described before.

If, however, it is determined that the GAP profile does not comprise any unique fingerprint of the target mobile device 108A (the “No” branch of step 410), the orientation mobile device 108B then establishes a BLE connection with the target mobile device 108A using GATT (step 412), and analyzes the GATT profile to extract a unique fingerprint therefrom (step 414).

As described above, a BLE signal with GATT profile comprises a plurality of predefined services, and each service comprises a unique service UUID and one or more characteristics. As different device manufacturers and/or different service providers may provide different services with different characteristics, a suitable combination of the service UUIDs and characteristics may form a fingerprint that can uniquely identify the mobile device.

For example, in one embodiment, information in the GATT profile such as Local Name, Characteristic UUID and other information is used for sufficiently identifying the manufacturer of the device. After the device's manufacturer is identified, the orientation mobile device 108B identifies the possible target mobile device 108A by reading a unique value that the manufacturer thereof may use for device identification, such as a characteristics value, manufacturer data, and advertisement service data etc.

After identifying the device 108A, the orientation mobile device 108B reports the extracted unique fingerprint to the cloud (step 416) together with other data such as its own location and a timestamp, as described before.

The process 400 then ends (step 418), and the orientation mobile device 108B can scan another BLE signal.

An advantage of this embodiment is that, by using GAP and GATT, the system is more flexible to adapt to mobile devices of various manufacturers and/or service providers. For example, due to the extensibility of GAP, custom profiles can be built in mobile devices' BLE signals to meet various business requirements. While challenging, it is readily available to determine a combination of information in a custom-built profile for uniquely identifying a mobile device. Such a combination may be particular to each device manufacturer and/or service provider, and may be stored in the cloud and cached to an orientation device for use as needed. In above embodiments, a cloud computer system and a method for locating a target mobile device 108A are described. In this disclosure, a “target mobile device” broadly refers to a mobile device to be located, and in some embodiments may be a lost mobile device. As described above, the target mobile device 108A broadcasts a wireless beacon, e.g., a BLE beacon. Examples of such target mobile devices may be a smartphone employing BLE technology, a luggage having a BLE beacon component, a key or keys having or attached to a BLE beacon device, or the like. Those skilled in the art appreciate that, in some embodiments, the target mobile devices, such as a luggage or key having a BLE beacon component, may be simply a BLE beacon transmitter that do not scan or receive other devices' beacons, nor run any application programs. However, in some other embodiments, the target mobile devices may be a smartphone, a tablet or the like that runs suitable application programs and, while broadcasting BLE beacons, also scan and receive other devices' beacons. In fact, a mobile device 108B described above may become a lost or target mobile device 108A when it is lost or being located.

In above embodiments, the system comprises a cloud and a plurality of mobile devices each having a unique identity. The cloud maintains a list of target mobile devices that have been requested, e.g., from their owners, to locate, and determines one or more orientation mobile devices to located the target mobile devices in the list. In some embodiments, the target mobile devices in the list are prioritized with respective priority weights, which may be dependent upon various factors such as predetermined rankings, the time of the search requests received and/or the distance between an orientation mobile device and a target mobile device. In some embodiments, the system may comprise two or more subsystems, each having its own cloud, and the two or more subsystems collaborating via a central cloud. A request of searching a target mobile device received by one subsystem may be forwarded to one or more other subsystems so that the orientation mobile devices in the one or more other subsystems can also search for the target mobile device.

In some embodiments, the processes described above may be implemented as computer executable code stored in computer readable medium or media. The computer readable medium or media may be non-transitory. The entirety, or a portion thereof, the computer executable code may be read and executed by one or more processing structures as needed for performing the processes described above.

Although embodiments have been described above with reference to the accompanying drawings, those of skill in the art will appreciate that variations and modifications may be made without departing from the scope thereof as defined by the appended claims.

What is claimed is:

1. A system for determining the position of at least one target mobile device, each of the at least one target mobile device transmitting a wireless signal, the system comprising:
a computer cloud having one or more servers; and
one or more orientation mobile devices in communication with the computer cloud; wherein, for each of the at least one target mobile device, the computer cloud performs actions of:
receiving a request of a position of said target mobile device;
determining a selected group of the one or more orientation mobile devices based on a set of initial information of said target mobile device;
instructing the selected group of orientation mobile devices to search for said target mobile device;
receiving reference position information from at least one of the selected group of orientation mobile devices;
determining the position of said target mobile device based on the received reference position information; and
reporting the determined position of said target mobile device;
and wherein each of the selected group of orientation mobile devices, upon receiving the instruction of searching the target mobile device, performs actions of:
determining the position of said orientation mobile device;
detecting the wireless signal transmitted from the target mobile device;
identifying an identity of the target mobile device from the detected wireless signal; and
reporting detection of the target mobile device, said detection reporting comprising at least the position of said orientation mobile device.

2. The system of claim 1 wherein said detection reporting step further comprises a timestamp indicating the time of detection of the target mobile device.

3. The system of claim 1 wherein each of the selected group of orientation mobile devices, upon receiving the instruction of searching the target mobile device, further performs actions of:
measuring the strength of the detected wireless signal; and
determining a distance between said orientation mobile device and the target mobile device based on a comparison of the measured signal strength and a predefined reference signal strength.

4. The system of claim 1 wherein the computer cloud further performs actions of:
determining a priority weight for each of the at least one target mobile device.

5. The system of claim 1 wherein the wireless signal is a Bluetooth Low Energy (BLE) signal.

6. The system of claim 5 wherein the BLE signal encodes a (UUID, Major ID, Minor ID) triplet for uniquely identifying the target mobile device.

7. The system of claim 5 wherein the BLE signal is structured with a BLE Generic Access Profile (GAP).

8. The system of claim 7 wherein said identifying an identity of the target mobile device from the detected wireless signal comprises:
determining a unique fingerprint from the GAP profile; and
if said determining a unique fingerprint from the GAP profile fails, establishing a connection with said target mobile device using a BLE Generic Attribute Profile (GATT), for determining a unique fingerprint therefrom.

9. The system of claim 1 wherein said set of initial information comprises an initial location of the target mobile device.

10. The system of claim 9 wherein the initial location of the target mobile device is the last known location of the target mobile device.

11. A method for determining the position of at least one target mobile device, said each of the at least one target mobile device transmitting a wireless signal, the method comprising, for each of the at least one target mobile device:
receiving a request of a position of said target mobile device;
determining a selected group of the one or more orientation mobile devices based on a set of initial information of said target mobile device;
detecting, at least some of the selected group of orientation mobile devices, the wireless signal transmitted from the target mobile device;
identifying an identity from the detected wireless signal;
determining the positions of the at least some of the selected group of orientation mobile devices;
determining the position of said target mobile device using at least the determined positions of the at least some of the selected group of orientation mobile devices; and
reporting the determined position of said target mobile device.

12. The method of claim 11 wherein said reporting the determined position of said target mobile device further comprises reporting the determined position of said target mobile device with a timestamp indicating the time of detection of the target mobile device.

13. The method of claim 11 further comprising:
measuring the strength of the detected wireless signal; and
determining a distance between the target mobile device and each of the at least some of the selected group of orientation mobile devices based on a comparison of the measured signal strength and a predefined reference signal strength.

14. The method of claim 11 further comprising:
determining a priority weight for each of the at least one target mobile device.

15. The method of claim 11 wherein the wireless signal is a Bluetooth Low Energy (BLE) signal structured with a BLE Generic Access Profile (GAP).

16. The method of claim 15 wherein said identifying an identity of the target mobile device from the detected wireless signal comprises:
determining a unique fingerprint from the GAP profile; and
if said determining a unique fingerprint from the GAP profile fails, establishing a connection with said target mobile device using a BLE Generic Attribute Profile (GATT), for determining a unique fingerprint therefrom.

17. An orientation mobile device for determining the position of at least one target mobile device, said orientation mobile device comprising:
a processing structure; and
a wireless communication component functionally coupled to the processing structure and for receiving a wireless signal;
wherein said processing structure executing program-executable code for:
receiving a list of identities representing one or more target mobile devices, each identity in the list being associated with a priority weight;
selecting at least one identity for searching based on the priority weights of the identities in the list;
receiving a wireless signal;
determining an ID from the received wireless signal;
determining that the ID of the received wireless signal matches at least one of the selected identities; and
reporting detection of a target mobile device, said detection reporting comprising at least the position of the orientation mobile device.

18. The orientation mobile device of claim 17 wherein said detection reporting further comprises a timestamp indicating the time of detection of the target mobile device.

19. The orientation mobile device of claim 17 wherein said processing structure further executes program-executable code for:
measuring the strength of the received wireless signal; and
determining a distance between the target mobile device and the orientation mobile device based on a comparison of the measured signal strength and a predefined reference signal strength.

20. The orientation mobile device of claim 17 wherein the wireless signal is a Bluetooth Low Energy (BLE) signal structured with a BLE Generic Access Profile (GAP), and wherein said determining an ID from the received wireless signal comprises:
determining a unique fingerprint as the ID from the GAP profile; and
if said determining a unique fingerprint from the GAP profile fails, establishing a connection with said target mobile device using a BLE Generic Attribute Profile (GATT), for determining a unique fingerprint therefrom as the ID.
